(19) United States
(12) Patent Application Publication
(10) Pub. No.: US 2024/0348440 A1
(43) Pub. Date: Oct. 17, 2024

(54) BLOCKCHAIN SYSTEM WITH SECURE RESTORATION OF KEY PAIRS TECHNICAL FIELD

(71) Applicant: ULTRA Corporation OU, Tallinn (EE)

(72) Inventors: David Paul J. Hanson, Azeitao (PT); Adam Du, Kellyville (AU)

(21) Appl. No.: 18/134,448

(22) Filed: Apr. 13, 2023

(51) Int. Cl. H04L 9/08; H04L 9/00; H04L 9/30

(52) U.S. Cl. CPC H04L 9/0894; H04L 9/3073; H04L 9/50

(57) ABSTRACT

A processor-based method of restoring a key pair to a user of a blockchain can include receiving key restore request data and submitting a transaction to the blockchain. The key restore request data can include at least: a user identifier associated with the blockchain user, and a first public key to be associated with the user identifier; The transaction can include the user identifier associated with the blockchain user, the public key to be associated with the user identifier, and an instance of identity provider (IDP) attestation data. The instance of IDP attestation data can include a signature of an identity provider over data fields comprising, at least: data indicative of the user identifier, and data indicative of the public key to be associated with the user identifier.

### TECHNICAL FIELD

The presently disclosed subject matter relates to blockchains, and in particular to management of users' private key/public key pairs.

### BACKGROUND

Problems of private key/public key management have been recognized in the conventional art and various techniques have been developed to provide solutions.

### GENERAL DESCRIPTION

According to one aspect of the presently disclosed subject matter there is provided a processor-based method of restoring a key pair to a user of a blockchain, the method comprising:
a) receiving key restore request data, the key restore request data comprising, at least:
   a user identifier associated with the blockchain user, and
   a first public key to be associated with the user identifier; and
b) submitting a transaction to the blockchain, the transaction comprising:
   the user identifier associated with the blockchain user,
   the public key to be associated with the user identifier, and
   an instance of IDP attestation data, comprising:
      a signature of the identity provider over data fields comprising, at least:
         data indicative of the user identifier, and
         data indicative of the public key to be associated with the user identifier.

In addition to the above features, the system according to this aspect of the presently disclosed subject matter can comprise the feature listed below:
(i) additionally comprising, prior to b):
   receiving one or more additional instances of IDP attestation data, each additional instances of IDP attestation data comprising:
      a signature of a respective additional identity provider over data fields comprising, at least:
         data indicative of the user identifier, and
         data indicative of the public key to be associated with the user identifier; and
wherein the submitted transaction further comprises the one or more additional instances of Identity Provider (IDP) attestation data.
(ii) the receiving is via a locally-authenticated communication channel.

According to another aspect of the presently disclosed subject matter there is provided a computer system of restoring a key pair to a user of a blockchain, the system comprising a processing circuitry configured to:
a) receive key restore request data, the key restore request data comprising, at least:
   a user identifier associated with the blockchain user, and
   a first public key to be associated with the user identifier; and
b) submit a transaction to the blockchain, the transaction comprising:
   the user identifier associated with the blockchain user,
   the public key to be associated with the user identifier, and
   an instance of IDP attestation data, comprising:
      a signature of the identity provider over data fields comprising, at least:
         data indicative of the user identifier, and
data indicative of the public key to be associated with the user identifier.

This aspect of the disclosed subject matter can further optionally comprise feature (i)-(ii) listed above with respect to the method.

According to another aspect of the presently disclosed subject matter there is provided a computer program product comprising a computer readable non-transitory storage medium containing program instructions, which program instructions when read by a processor, cause the processing circuitry to perform a method of restoring a key pair to a user of a blockchain, the method comprising:
a) receiving key restore request data, the key restore request data comprising, at least:
   a user identifier associated with the blockchain user, and
   a first public key to be associated with the user identifier; and
b) submitting a transaction to the blockchain, the transaction comprising:
   the user identifier associated with the blockchain user,
   the public key to be associated with the user identifier, and
   an instance of IDP attestation data, comprising:
   a signature of the identity provider over data fields comprising, at least:
      data indicative of the user identifier, and
      data indicative of the public key to be associated with the user identifier.

This aspect of the disclosed subject matter can further optionally comprise feature (i)-(ii) listed above with respect to the method.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates an example enhanced blockchain system employing a method of restoring a key pair to a blockchain user, in accordance with some embodiments of the presently disclosed subject matter;

FIG. 2A illustrates a series of inter-entity transactions for creation of a user account on a blockchain, in accordance with some embodiments of the presently disclosed subject matter;

FIG. 2B illustrates inter-entity transactions for pre-stipulating one or more identity providers (IDPs) to be empowered to assign new public keys to a user, in accordance with some embodiments of the presently disclosed subject matter;

FIG. 2C illustrates a series of inter-entity transactions for associating a new key pair with a blockchain user—for example after a private key loss or possible private key compromise, in accordance with some embodiments of the presently disclosed subject matter;

FIG. 3 illustrates an example IDP attestation data structure, in accordance with some embodiments of the presently disclosed subject matter;

FIG. 4 illustrates a flow diagram of an example method of processing a key restore request received by an IDP, in accordance with some embodiments of the presently disclosed subject matter; and

FIG. 5 illustrates a flow diagram of an example method executed by a block producer system to associate a new public key/private key pair with a user of the blockchain, in accordance with some embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “comparing”, “determining”, “calculating”, “receiving”, “providing”, “obtaining”, “validating”, “preparing” or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the processor, mitigation unit, and inspection unit therein disclosed in the present application.

The terms “non-transitory memory” and “non-transitory storage medium” used herein should be expansively construed to cover any volatile or non-volatile computer memory suitable to the presently disclosed subject matter.

The operations in accordance with the teachings herein may be performed by a computer specially constructed for the desired purposes or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein.

In blockchain systems, assets are typically associated with a public key/private key pair. A user is required to maintain and access his or her key pair while at the same time keeping it secure. These requirements have led to various solutions, including “hardware wallets”, and most commonly by utilizing a “cryptocurrency exchange” or similar entity (thereby outsourcing the key management to a third-party). Catastrophic key lost remains a possibility, and assets of users have been irretrievably lost due to key loss or key compromise.

Some embodiments of the presently disclosed subject matter are directed to systems and methods enabling restoration of lost keys or replacement of potentially compromised keys. In some embodiments of the presently disclosed subject matter, this is accomplished utilizing a chain of entities that are termed “identity service providers” (IDPs). An enhanced blockchain system includes a mechanism for user specification of a chain of personally-selected IDPs, and then of subsequent IDP restoration of the user's key pair.

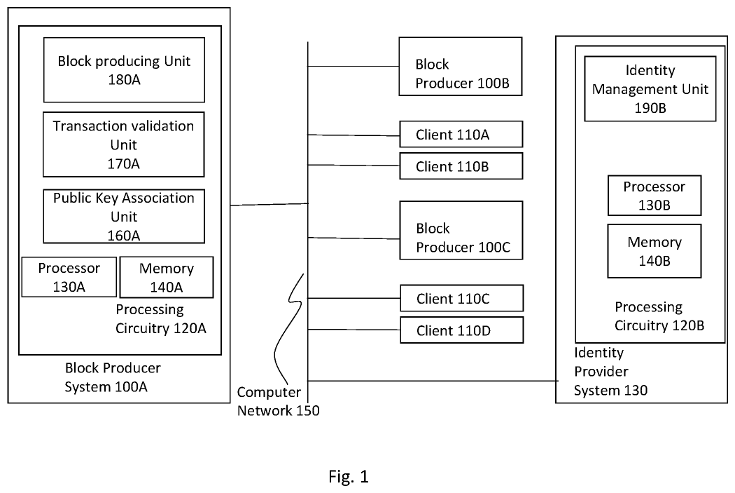

Attention is now directed to FIG. 1, which illustrates an example enhanced blockchain system employing a method of restoring a key pair to a blockchain user, in accordance with some embodiments of the presently disclosed subject matter.

The blockchain system can include a computer network 150. Computer network 150 can be a suitable network which allows communications of transaction requests and of produced blocks of the blockchain among blockchain clients 110A 110B 110C 110D and block producer systems 100A 100B 100C. By way of non-limiting example: computer network 150 can be the public internet.

Blockchain clients 110A 110B 110C 110D can be computer systems (e.g. personal computers, mobile phones, tablets, etc.) which conduct blockchain transactions with e.g. block producer systems 100A 100B 100C. For example: blockchain client 110A can transmit, over computer network 150, a request to transfer cryptocurrency owned by a particular user A (e.g. associated with a blockchain key pair) to a different blockchain user B. In some examples, one or more blockchain client of blockchain clients 110A 110B 110C 110D can be a server computer system of a cryptocurrency exchange, which performs transactions on behalf of multiple blockchain users (each one using a unique blockchain key pair).

Block producer systems 100A 100B 100C can produce blocks of the blockchain—for example: in response to blockchain client transaction requests—as known in the art. In some examples, block producer systems 100A 100B 100C can receive and validate each other's produced blocks, and can utilize a mechanism such as proof-of-work, proof-of-stake, etc. to produce consensus regarding which blocks will be added next to the authoritative blockchain—as known in the art.

In some embodiments, block producer systems 100A 100B 100C can produce blocks of a cryptocurrency system such as bitcoin, Ethereum, EOS etc.

Block producer system 100A can include processing circuitry 120A, which can include processor 130A and memory 140A.

Processor 130A can be a suitable hardware-based electronic device with data processing capabilities, such as, for example, a general purpose processor, digital signal processor (DSP), a specialized Application Specific Integrated Circuit (ASIC), one or more cores in a multicore processor, etc. Processor 130A can also consist, for example, of multiple processors, multiple ASICs, virtual processors, combinations thereof etc.

Memory 140A can be, for example, a suitable kind of volatile and/or non-volatile storage, and can include, for example, a single physical memory component or a plurality of physical memory components. Memory 140A can also include virtual memory. Memory 140A can be configured to, for example, store various data used in computation.

Processing circuitry 120A can be configured to execute several functional modules in accordance with computer-readable instructions implemented on a non-transitory computer-readable storage medium. Such functional modules are referred to hereinafter as comprised in the processing circuitry. These modules can include, for example, transaction validation unit 160A, and public key association unit 170A, and block producing unit 180A.

Public key association unit 160A can, in some examples, maintain internal tables which associate user identifiers with public keys, thereby enabling block producer system 100A (e.g. transaction validation unit 170A) to validate incoming transactions for signature authenticity. In other examples, enabling block producer system 100A (e.g. transaction validation unit 170A) obtains public keys associated with user identifiers via a different method.

Transaction validation unit 170A can validate incoming transactions for signature authenticity, which can then make them eligible for inclusion in a block of the blockchain.

Transaction validation unit 170A can receive public key creation or public key update transactions, and (after validation) instruct public key association unit 160A to accordingly create or update the association of the user identifier with a public key.

Block producing unit 180A can also produce blocks of the blockchain, and can produce blocks that include transactions that associate the user identifier with a new public key, as described in detail hereinbelow.

Identity provider system 130 can be a computer system associated with a trusted entity such as a bank or other financial institution, a provider of internet information services (e.g. a search provider, email provider etc.), a government entity etc.

In some embodiments, identity provider system 130 can conduct transactions on the blockchain.

In some embodiments, identity provider system 130 can provide a secured interface enabling human users to identify and authenticate themselves. By way of non-limiting example, identity provider system 130 can provide a web-based login/password interface (e.g. utilizing Hypertext Transfer Protocol Secure protocol (HTTPS), or HTTPS in combination with a second authorization factor such as cellphone confirmation). By way of further non-limiting example, identity provider system 130 can provide a telephone number which users can call to provide identifying information to a human operator. By way of further non-limiting example, identity provider system 130 can provide a protocol-based interface verifying the presence of an identifying/authenticating hardware device in the user's computer.

In some embodiments, identity provider system 130 can utilize the authentication mechanism (such as web-based login) establish an authenticated communication channel with client 110A 110B 110C 110D.

In some embodiments, identity provider system 130 can, e.g., in response to a request from an user authenticated in this manner, associate a blockchain key pair (e.g. supplied by client 110A 110B 110C 110D to the IDP over the authenticated communication channel) with the authenticated user's user identifier, and then conduct blockchain transaction(s) that propagate the association of the user identifier and the new key pair to the rest of the blockchain. In this manner, a mechanism is provided that enables a user to update his or her key pair—for example: in response to a loss or potential compromise of the key pair.

In some examples, a client 110A 110B 110C 110D utilizes multiple identity providers (each with e.g. its own instance of identity provider system 130) to update a user's key pair, as described hereinbelow.

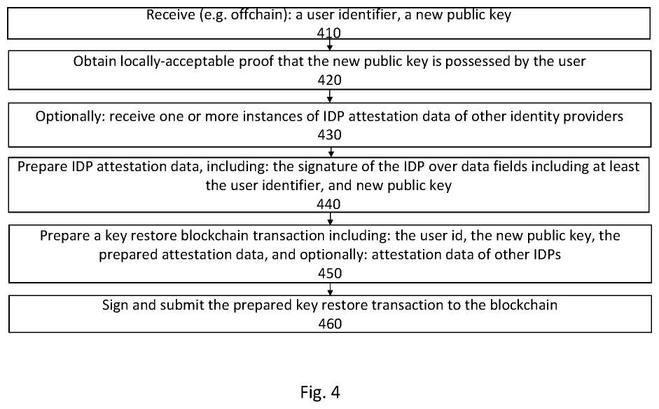

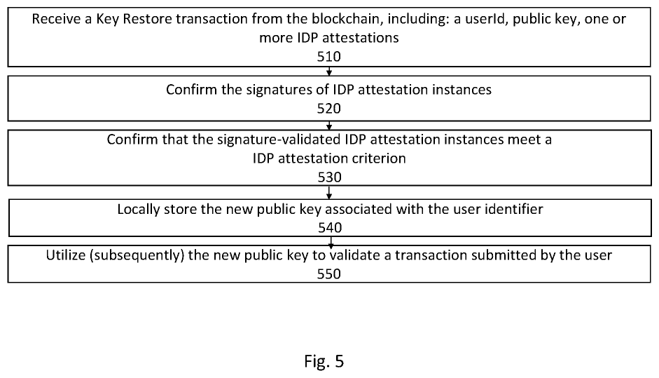

Example methods performed by identity provider system 130 and block producer system 100A to assign a new key pair to a blockchain user are detailed below in reference to FIGS. 4-5.

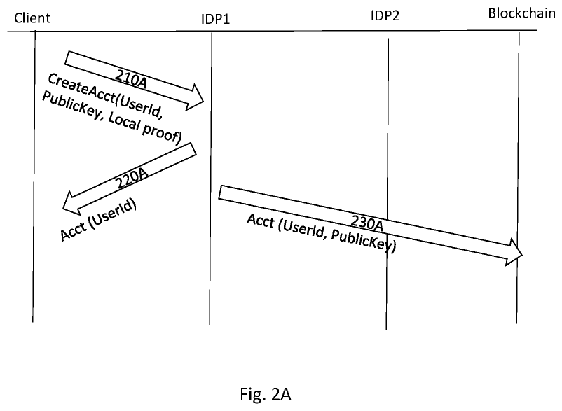

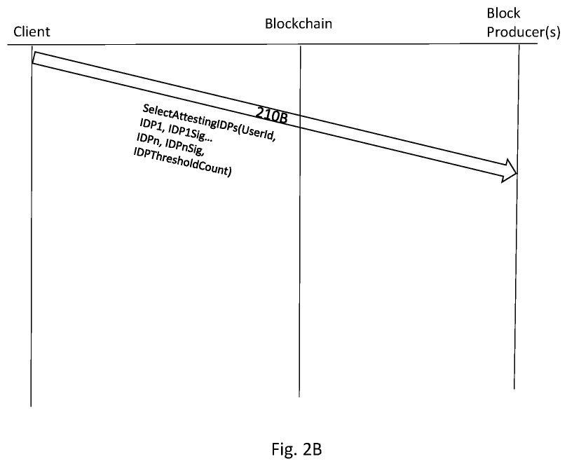

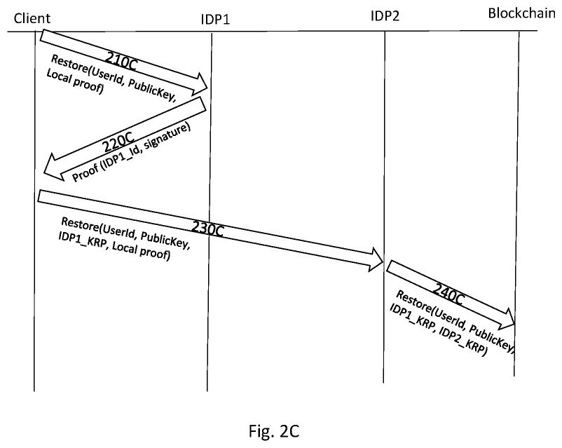

In the example described in FIG. 2A, a client system 110A can initiate a transaction 210A with an identity provider IDP1, so as to create an account on the blockchain. To do this, the client system can supply a unique user identification, the user's public key, and a “locally-valid proof” of his or her identity. IDP1 can then acknowledge 220A the creation of the account.

It is noted that the transaction 210A/acknowledgment 220A “handshake” can take place via a variety of protocols or transaction mechanisms.

In some embodiments, identity provider IDP1 enables the transaction/response by providing a web-based user interface. In such embodiments, the user can log in to an IDP-provided website using e.g. web-based (or 2-factor based) authentication. In this case, the user identification can be a userId string that is unique in the particular blockchain system and is provided to the user e.g. by the IDP1, or by a different entity. In this case, the “local proof” of identity can be the web-based login to the IDP1-supplied website. The acceptance of the account creation transaction by the website can then constitute the acknowledgement 220A.

In some other embodiments, IDP1 can receive the user's account creation transaction via a telephone call that is responded to by a human operator. In this case, the “local proof” might be the ability to answer certain security questions.

In some other embodiments, the account creation transaction and response can take place using a different method or protocol.

In some examples, block producer nodes 100A 100B 100C are pre-configured to recognized certain IDPs to conduct identity-based transactions on the blockchain.

Accordingly, following receipt of an account creation request transaction from a user, IDP1 can then conduct a blockchain transaction 230A (e.g. on the enhanced blockchain system of FIG. 1) instructing association of the userId with the user-supplied public key. IDP1 can sign this blockchain transaction with its own private key. Receiving block producer nodes 100A 100B 100C can validate the signature of IDP1, confirm that IDP1 is a recognized identity provider, and hereforward recognize transactions that the new user has signed with his or her private key.

FIG. 2B illustrates an example blockchain transaction of pre-stipulating one or more IDPs to be empowered to assign new public keys to a user, the transaction being implemented in an enhanced key recovery-supporting blockchain, in accordance with some embodiments of the presently disclosed subject matter.

A client system 110A can transmit transaction 210B (of a particular user) in order to stipulate IDPs (e.g. a number of specific IDPs) that are hereforward empowered to attest to that user's identity and associate a new public key (and implicitly private key) with that user.

Transaction 210B can, as non-limiting examples, include the following parameters:
UserId: a user identity such as the unique identifier provided to the user upon initial blockchain account creation
For each attesting IDP, an IDP Identifier and) optionally) an associated IDP “proof”
   The IDP identifier can be, for example, a blockchain-wide unique string denoting the IDP, a hash of the IDP's public key, or some other suitable identifier
   The associated IDP proof can be an IDP signature (i.e. with its private key) of a text consisting of—for example: the userID, a string such as “SelectAttestingIDPs”, and a timestamp or counter.
IDP threshold count: a counter indicating the minimum number of IDPs whose attestation is required to update a user's public key. For example, transaction 210B might specify 5 attesting IDPs, but require attestations from only 3 of them in order to update a public key associated with a user.

Transaction 210B can bear the signature of the user issuing the transaction.

A block producer 100A 100B 100C can receive transaction 210B and include it in a blockchain block that becomes part of the authoritative blockchain.

Upon receipt of the blockchain block including transaction 210B, block producers 100A 100B 100C can, for example, (e.g. after validating the signature of the transaction, and validating the IDP proofs) record the association of the userId with the attesting IDPs. Alternatively, block producers 100A 100B 100C can use a different mechanism for determining which attesting IDPs were selected by the user-such as searching backward in the authoritative blockchain for transaction 210B.

Upon receipt of the blockchain block including transaction 210B, client system 110A can regard transaction 210B as having completed successfully.

FIG. 2C illustrates an example transaction sequence of associating a new key pair with a blockchain user—for example after a private key loss or possible private key compromise, in accordance with some embodiments of the presently disclosed subject matter.

In some embodiments, a user can pre-stipulate to the blockchain system that one or more specific IDPs are to be recognized for the purpose of associating a new key pair with a user id. By way of non-limiting example, a user can utilize a mechanism such as the one described above, with reference to FIG. 2B.

FIG. 2C illustrates an example where the client pre-stipulated 2 specific IDPs. It will be understood that this mechanism can be similarly applied with a single IDP, or with more than 2 IDPs.

A client system 110A can initiate a transaction 210C with an identity provider IDP1, requesting association of the user id with a new public key (and requesting implicitly, in some examples, the disassociation of the user id with e.g. a single old public key). As in FIG. 2A, the transaction 210C again includes the unique user identification, the user's public key, and a “locally-valid proof” of his or her identity.

As previously described in FIG. 2A, IDP1 can implement this transaction/response using a web-based interface, or by a different suitable mechanism. In some such examples, the web-based authentication method constitutes the locally-valid proof of identity.

IDP1 can then attempt to validate the key restore transaction by confirming the validity of the local proof. If the validation is successful, IDP1 can then transmit “key restore proof data” (KRP data) (220C) to the client system. The key restore confirmation data can include identifying information of IDP1, together with e.g. a private-key signature by IDP1 over a sequence of data including the userid and new user public key. In some embodiments, the sequence of data that is signed can also include e.g. as a counter or timestamp to be used as an “anti-replay” mechanism, so as to prevent an attacker from reusing old KRP data.

Next, the client system 110A can initiate a second restore transaction 230C—this time to IDP2. In addition to the user id, public key, and “local proof”, transaction 230C can include the KRP data supplied by IDP1 (as described above with reference to transaction response 220C).

IDP2 can implement this transaction/response using a web-based interface, or by a different suitable mechanism. In some such examples, the web-based authentication method constitutes the locally-valid proof of identity.

IDP2 can then attempt to validate the key restore transaction by confirming the validity of the local proof, as well as by validating the signature of IDP1 in the KRP data.

If the validation is successful, IDP2 can next evaluate whether the key restoration prestipulation associated with the user id has been satisfied (e.g. in this case that both IDP1 and IDP2 have confirmed the client identity). After IDP2 has confirmed that the key restoration prestipulation has been met, IDP2. can then transmit a user key restore transaction 240C on the blockchain.

The blockchain user key restore transaction 240C can include:
the user id
the new public key to be associated with the user id
the KRP data that was provided by IDP1 to the client
an IDP2-prepared additional section of KRP data, consisting, for example, identifying information of IDP2, together with e.g. a private-key signature by IDP2 over a sequence of data including the userid and public key, and an optional counter or timestamp.

The blockchain transaction can then be processed by a block producer system of the block producer systems 100A 100B 100C, and become part of the authoritative blockchain. The new public key is thus hereforward associated with the user id, and the user can then utilize the new private key/public key pair to perform transaction on assets (e.g. digital coins) that are associated with the userid.

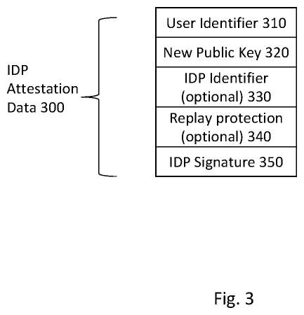

Attention is directed to FIG. 3, which illustrates an example IDP attestation data structure, in accordance with some embodiments of the presently disclosed subject matter.

IDP attestation data 300 can be carried in blockchain messages originated in an IDP, as described herein.

IDP attestation data 300 can include user identifier 310 and new public key 320. IDP attestation data 300 can further optionally include IDP identifier 330, which can contain the identity of the IDP that is generating the attestation data.

IDP attestation data 300 can further optionally include replay protection 340 (e.g. a timestamp or counter to prevent replay attacks).

IDP attestation data 300 can include the IDP signature 350. This signature can be a digital signature created by the IDP across the other fields of the IDP attestation data 300, i.e. user identifier 310, new public key 320, (optionally) IDP identifier 330, and (optionally) replay protection 340.

The IDP can create this digital signature using a private key, so that the signature can then be verified by an eventual recipient (i.e. by using the corresponding public key).

Attention is directed to FIG. 4, which illustrates a flow diagram of an example method of processing a key restore request received by an IDP, in accordance with some embodiments of the presently disclosed subject matter.

Processing circuitry 120B of identity provider system 130 (e.g. identity management unit 190B) can receive (410) (for example: via an off-chain mechanism), a key restore request from a blockchain client 110A 110B 110C 110D.

The key restore request can be a grouping of data that includes data indicative of:
a user identifier which is, for example, unique within the blockchain system
a new public key to be associated with the user identifier

The data in the key restore request can be received in one operation from one data source, or in more than one operation or from more than one source.

Processing circuitry 120B of identity provider system 130 (e.g. identity management unit 190B) can next obtain (420) “locally-acceptable” proof that the new public key is possessed by the user. Each Identity Provider can determine what constitutes locally-acceptable proof.

In some examples, the IDP receives proof that the key restore request was submitted by the user associated with the user identifier, and regards this as proof that the new public key is possessed by the user.

In some examples, the IDP regards biometric evidence (e.g. a handprint at an automatic teller machine-type device) as proof that a key restore request was submitted by the user.

In some examples, the IDP regards web-based 2-factor authentication as proof that a key restore request was submitted by the user.

In some examples, the IDP regards responses to cryptographic challenge response protocols (e.g. as performed by special hardware) as proof that a key restore request was submitted by the user.

In some examples, the IDP regards a command line entered on a management console—by a human operator speaking to a user on the telephone—as proof that a key restore request was submitted by the user.

In some examples, the IDP regards other evidence as proof that the key restore request was submitted by the user, or that that the new public key is possessed by the user.

It is noted that in some embodiments, processing circuitry 120B (e.g. identity management unit 190B) can obtain “locally-acceptable” proof that the new public key is possessed by the user prior to receiving the key restore request.

By way of non-limiting example, processing circuitry 120B (e.g. identity management unit 190B) can authenticate a user (e.g via a web-based user interface or mechanisms listed hereinabove), and set up an authenticated communication channel (such as secure hypertext transfer protocol (HTTPS), or other authenticated channel establishment mechanisms as known in the art. In this example, the successful establishment of the channel can be regarded as “locally-acceptable” proof. The key request can then be received by the IDP over the authenticated communication channel.

Processing circuitry 120B (e.g. identity management unit 190B) can then-optionally—receive (430) one or more instances of IDP attestation data (for the userId and new public key) that were prepared by other IDPs. In some embodiments, processing circuitry 120B (e.g. identity management unit 190B) receives the instances of IDP attestation data of other IDPs as part of the key restore request. In some embodiments, processing circuitry 120B (e.g. identity management unit 190B) receives the instances of IDP attestation data of other IDP through other mechanisms.

Processing circuitry 120B (e.g. identity management unit 190B) can then prepare (440) IDP attestation data.

IDP attestation data can be a data structure that is “signed” by the IDP, and can signify that the IDP “attests” to the possession of the public key by the user associated with the user identifier. Accordingly IDP attestation data can include:
data indicative of the user identifier
data indicative of the new public key
the digital signature of the IDP over data indicative of the user identifier and new public key

Optionally, the IDP attestation data can further include:
an identifier of the IDP (usable by a recipient in order to validate the signature)
a counter or timestamp (to prevent replay attacks)

Optionally, the IDP attestation data can further include other data.

Processing circuitry 120B (e.g. identity management unit 190B) can then prepare and transmit (450) a key restore blockchain transaction including:
data indicative of the user identifier
data indicative of the new public key
data indicative of the prepared IDP attestation data

Optionally, the key restore blockchain transaction can further include:
data indicative of IDP attestation data instances of other IDPs

Processing circuitry 120B (e.g. identity management unit 190B) can then sign and submit (460) the prepared blockchain transaction to the blockchain.

Attention is directed to FIG. 5, which illustrates an example method executed by a block producer system to associate a new public key/private key pair with a user of the blockchain, in accordance with some embodiments of the presently disclosed subject matter.

Processing circuitry 120A of block producer system 100A (e.g. transaction validation unit 170A) can receive 510 a key restore transaction—e.g. originally transmitted by an IDP—that has been, for example, included in a block of the blockchain and has had the block signature validated. As described hereinabove, the key restore transaction can include a userId, a new public key, and IDP attestation data from one or more IDPs.

Processing circuitry 120A (e.g. transaction validation unit 170A) can next confirm 520 signatures of one or more of the instances of IDP attestation data. In some embodiments, block producer system 100A (e.g. public key association unit 160A)) only confirms the signatures of IDP attestation data instances if they have been signed by IDPs which were prestipulated by the user as acceptable IDPs for key restoration.

In some embodiments, data indicative of the identities of the IDPs is included within the IDP attestation data (as described hereinabove with reference to FIG. 4), so that processing circuitry 120A (e.g. transaction validation unit 170A) can access a public key associated with the signing IDP in order to confirm the signature of the IDP attestation data instance.

In some other embodiments, processing circuitry 120A (e.g. transaction validation unit 170A) accesses public keys of signing IDPs in a different manner.

Processing circuitry 120A (e.g. transaction validation unit 170A) can next confirm 530 that the signature-validated IDP attestation instances meet an IDP attestation criterion.

In some embodiments, the IDP attestation criterion is whether the count of the signature-validated IDP attestation instances (from IDPs that were prestipulated by the user as acceptable IDPs for key restoration) meets a prestipulated threshold number.

In some other embodiments, other IDP attestation criteria can be utilized. For example: some embodiments might require that a particular IDP always provides IDP attestation data.

By way of non-limiting example: if the prestipulated IDP requirements for the particular userId include the requirement that IDP1 and IDP2 must each provide IDP attestation data, then processing circuitry 120A (e.g. transaction validation unit 170A)) can confirm that the transaction does in fact include IDP attestation data from IDP1 and IDP2, and validate the signatures to confirm that the IDP attestation data is authentic. If the transaction does not satisfy the prestipulated IDP requirements, then processing of the transaction can terminate (i.e. the key restoration transaction is rejected by the block producer system 100A).

Once it has been confirmed that the IDP attestation criterion has been met, processing circuitry 120A (e.g. public key association unit 160A) can locally store 540 the new public key associated with the UserId. By doing this block producer system 100A (e.g. public key association unit 160A) can enable transaction processing when a transaction signed with the new key arrives. In some embodiments, processing circuitry 120A (e.g. public key association unit 160A) does not locally store 550 the new public key, but accesses it when needed e.g. from the authoritative blockchain record.

Processing circuitry 120A (e.g. public key association unit 160A) can then utilize 550 (subsequently) the new public key to validate a transaction submitted by the user.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A processor-based method of restoring a key pair to a user of a blockchain, the method comprising:
a) receiving key restore request data, the key restore request data comprising, at least:
a user identifier associated with the blockchain user, and
a first public key to be associated with the user identifier; and
b) submitting a transaction to the blockchain, the transaction comprising:
the user identifier associated with the blockchain user,
the public key to be associated with the user identifier, and
an instance of identity provider (IDP) attestation data, comprising:
a signature of an identity provider over data fields comprising, at least:
data indicative of the user identifier, and
data indicative of the public key to be associated with the user identifier.

2. The method of claim 1, additionally comprising, prior to b):
receiving one or more additional instances of IDP attestation data, each additional instance of IDP attestation data comprising:
a signature of a respective additional identity provider over data fields comprising, at least:
data indicative of the user identifier, and
data indicative of the public key to be associated with the user identifier; and
wherein the submitted transaction further comprises the one or more additional instances of IDP attestation data.

3. The method of claim 1, wherein the receiving is via a locally-authenticated communication channel.

4. A system of restoring a key pair to a user of a blockchain, comprising a processing circuitry configured to:
a) receive key restore request data, the key restore request data comprising, at least:
a user identifier associated with the blockchain user, and
a first public key to be associated with the user identifier; and
b) submit a transaction to the blockchain, the transaction comprising:
the user identifier associated with the blockchain user,
the public key to be associated with the user identifier, and
an instance of IDP attestation data, comprising:
a signature of an identity provider over data fields comprising, at least:
data indicative of the user identifier, and
data indicative of the public key to be associated with the user identifier.

5. A computer program product comprising a computer readable non-transitory storage medium containing program instructions, which program instructions when read by a processor, cause the processing circuitry to perform a method of restoring a key pair to a user of a blockchain, the method comprising:
a) receiving key restore request data, the key restore request data comprising, at least:
a user identifier associated with the blockchain user, and
a first public key to be associated with the user identifier; and
b) submitting a transaction to the blockchain, the transaction comprising:
the user identifier associated with the blockchain user,
the public key to be associated with the user identifier, and
an instance of IDP attestation data, comprising:
a signature of an identity provider over data fields comprising, at least:
data indicative of the user identifier, and
data indicative of the public key to be associated with the user identifier.

6. A processor-based method of restoring a key pair to a user of a blockchain, the method comprising:
a) obtaining a first transaction written to the blockchain, the first transaction comprising:
a user identifier associated with the blockchain user,
a first public key to be associated with the user identifier,
one or more instances of IDP attestation data, each instance of IDP attestation data comprising:
a signature of a respective identity provider over data fields comprising, at least:
data indicative of the user identifier, and
data indicative of the public key to be associated with the user identifier;
b) determining validity of IDP signatures on one or more of the IDP attestation data instances,
thereby giving rise to zero or more validated IDP attestation data instances;
c) responsive to a count of the validated IDP attestation data being at least one, and the validated IDP attestation data instances meeting a IDP attestation criterion:
utilizing the first public key to validate a second transaction written to the blockchain.

7. The method of claim 6, additionally comprising, prior to a):
receiving data indicative of respective identifiers of one or more IDPs that are prestipulated for the user identifier, and wherein the IDP attestation criterion is:
whether a count of validated IDP attestation data instances signed by respective prestipulated IDPs meets a given threshold.

8. The method of claim 7, wherein the data indicative of the respective identifiers of one or more IDPs that are prestipulated for the user identifier is received in one or more blockchain transactions.

9. A processor-based system of restoring a key pair to a user of a blockchain, the system comprising a processing circuitry that is configured to:
a) obtain a first transaction written to the blockchain, the first transaction comprising:
a user identifier associated with the blockchain user,
a first public key to be associated with the user identifier,
one or more instances of IDP attestation data, each instance of IDP attestation data comprising:
a signature of a respective identity provider over data fields comprising, at least:
data indicative of the user identifier, and
data indicative of the public key to be associated with the user identifier;
b) determine validity of IDP signatures on one or more of the IDP attestation data instances,
thereby giving rise to zero or more validated IDP attestation data instances;
c) responsive to a count of validated IDP attestation data instances being at least one, and the validated IDP attestation data meeting a IDP attestation criterion:
utilize the first public key to validate a second transaction written to the blockchain.

10. A computer program product comprising a computer readable non-transitory storage medium containing program instructions, which program instructions when read by a processor, cause the processing circuitry to perform a method of restoring a key pair to a user of a blockchain, the method comprising:
a) obtaining a first transaction written to the blockchain, the first transaction comprising:
a user identifier associated with the blockchain user,
a first public key to be associated with the user identifier,
one or more instances of IDP attestation data, each instance of IDP attestation data comprising:
a signature of a respective identity provider over data fields comprising, at least:
data indicative of the user identifier, and
data indicative of the public key to be associated with the user identifier;
b) determining validity of IDP signatures on one or more of the IDP attestation data instances,
thereby giving rise to zero or more validated IDP attestation data instances;
c) responsive to a count of validated IDP attestation data instances being at least one, and the validated IDP attestation data instances meeting a IDP attestation criterion:
utilizing the first public key to validate a second transaction written to the blockchain.
